(19) United States
(12) Patent Application Publication
(10) Pub. No.: US 2006/0191433 A1
(43) Pub. Date: Aug. 31, 2006

(54) Heat-sensitive recording material

(76) Inventors: Takashi Date, Tokyo (JP); Junpei Natsui, Tokyo (JP); Yoshimi Midorikawa, Tokyo (JP); Tatsuo Nagai, Tokyo (JP); Yoshihide Kimura, Tokyo (JP)

Correspondence Address: FLYNN THIEL BOUTELL & TANIS, P.C., 2026 RAMBLING ROAD, KALAMAZOO, MI, 49008-1631, US

(21) Appl. No.: 10/551,675

(22) PCT Filed: Mar. 31, 2004
(86) PCT No.: PCT/JP04/04667

§ 371 Date: Sep. 29, 2005

(30) Foreign Application Priority Data
Mar. 31, 2003 (JP) 2003-095944
Jun. 18, 2003 (JP) 2003-174132
Sep. 26, 2003 (JP) 2003-335594

(51) Int. Cl. B41N 3/00

(52) U.S. Cl. 101/463.1

(57) ABSTRACT

The present invention is a thermally sensitive recording medium comprising a thermally sensitive color developing layer containing colorless or pale colored basic leuco dye and a color developing agent as main components on a substrate, wherein said thermally sensitive recording layer is comprising an acrylic polymer obtained by copolymerization of alkyl acrylate, alkyl methacrylate and vinylsilane as monomer components and a colloidal silica, further, the present invention is a thermally sensitive recording medium, wherein said colloidal silica is possessing chain structure.

### FIELD OF THE INVENTION

The present invention relates to a thermally sensitive recording medium which utilize color developing reaction of a colorless or pale colored basic leuco dye with a color developing agent, in particular, relates to a thermally sensitive recording medium to which water resistance property fitted for the out door use such as a handy terminal paper or a delivery slip is provided.

### BACKGROUND OF THE INVENTION

In general, a thermally sensitive recording medium which obtains a recorded image utilizing color developing reaction by heat of a colorless or pale colored basic leuco dye with a color developing agent has advantages that coloring is very clear, noiseless at recording process and an equipment is relatively cheap, compact and maintenance free, and is widely applied in the field of a facsimile, a computer field, a recorder of various measuring instrument. Further, currently, a use as an output medium for various printers or plotters such as a handy terminal for outdoor measurement or a delivery slip besides a use for a label or a ticket are rapidly expanding. These usages are characterized to be often used in outdoor, therefore, quality and property characterizing to bear a use under more serious environment than conventional use, for example, water and high humid caused by rain, sunshine or high temperature in a car of midsummer season. Furthermore, it is necessary to provide good printing aptitude in these different uses, especially, in a use of delivery slip, good seal putting ability is an important quality.

Regarding improvement of water resistance, for example, in patent document 1, a method to add an isocyanate compound to add an adhesive such as polyvinylalcohol is disclosed. In the meanwhile, a method to improve water resistance by using hydrophobic resin emulsion such as vinyl acetate emulsion, acrylic emulsion or SBR latex as an adhesive for a thermally sensitive layer is known, however, since these method has a problem to cause accumulation of dregs on a head or sticking at recording process, actual use is not sufficiently accomplished yet. Further, a method to use a composite of colloidal silica and acrylic polymer as an adhesive is proposed in patent document 2 and a method to use self crosslinkable acrylic emulsion and colloidal silica is proposed in patent document 3, however, these methods can not achieve water resistance satisfying outdoor use and the problem of accumulation of dregs on a head is not suppressed sufficiently.
[Patent Document 1] JP-A-S55-159993 publication
[Patent Document 2] JP-A-H09-207435 publication
[Patent Document 3] JP-A-H09-266711 publication

While, in patent document 4, a water resistance coating composition prepared by blending colloidal silica to aqueous emulsion containing copolymer obtained by emulsion polymerization of vinylsilane and acrylic monomer is disclosed.
[Patent Document 4] JP-B-H03-47699 publication

### DISCLOSURE OF THE INVENTION

The object of the present invention is to provide a thermally sensitive recording medium which has excellent water resistance and good printing aptitude, characterizing less accumulation of dregs on a head and providing a good seal putting ability.

In the present invention, above mentioned object is dissolved by a thermally sensitive recording medium comprising a thermally sensitive color developing layer containing colorless or pale colored basic leuco dye and a color developing agent as main components on a substrate, wherein said thermally sensitive recording layer is comprising an acrylic polymer obtained by copolymerization of alkyl acrylate, alkyl methacrylate and vinylsilane as monomer components and a colloidal silica possessing chain structure, or, contains acrylic polymer obtained by copolymerization of at least acrylic alkyl, methacrylic alkyl and vinylsilane and colloidal silica possessing chain structure.

Further, in the present invention, it is effective that said acrylic polymer contains acrylnitlile and/or styrene as a monomer component.

### DESCRIPTION OF THE PREFERRED EMBODYMENT

The thermally sensitive recording medium of the present invention can be obtained, for example, by mixing a dispersion prepared by dispersing basic leuco dye color developing agent with a binder, a dispersion prepared by dispersing a color developing agent with a binder, an acrylic polymer, a colloidal silica possessing chain structure, a filler and other necessary additives so that prepare a coating for thermally sensitive layer and coating it on a substrate and dry it and forming a thermally sensitive layer.

Regarding a colloidal silica used in the present invention, its form is not restricted, however, a spherical type prepared by dispersing ultra fine particles of silicic anhydride in water or chain type possessing structural feature characterizing specific numbers of spherical colloidal silica, which is primary particle, are linked in linear or partially grafting and forms a rosary are desirably used. Said type can be used alone or can be used together with. Average particle size of primary particle of spherical colloidal silica or chain colloidal silica is desirable to be 5-50 nm, and said average particle size is desirably within range from 5 to 50 to average particle size 100 of acrylic polymer particle. While, the size (length) of chain colloidal silica measured by a laser scattering method is desirably 40-200 nm, and when the size is too small, since void fraction becomes low, sufficient effect for reducing dregs accumulated on a thermal head and water resistance can not be obtained and desirable lower limit is 40 nm. Further, from the view point of stability of coating, anionic colloidal dilica is suited, therefore the desirable pH of colloidal solution is approximately 7-11.

In particular, chain colloidal silica is preferably used in the present invention. The reason why an excellent effect is obtained in the present invention is not clear, however the reason can be guessed as follows. That is, heat resistance of acrylic polymer is low and easily fused by heat at printing process so that causes a ground of accumulation of dregs on a head, however, when contained together with colloidal silica in a thermally sensitive recording layer, colloidal silica surrounds acrylic polymer particles (hereinafter shortened to “acrylic particles”) and obstruct the transmitting of heat to acrylic particles effectively and accumulation of dregs on a head is protected. And in the present invention, fusion of acrylic particles becomes more difficult because heat sealing effect is enhanced by forming voids around acrylic particles based on three dimensional structure formed at the bonding process of colloidal silica with acrylic particle.

On the contrary, in a case when the acrylic particles are fused, it is considered that the fused product is absorbed into voids formed by using chain colloidal silica and formation of dregs on a head is remarkably controlled. The void forming function by chain colloidal silica improves concurrently an absorbency and a preserving ability of an inkpad ink so that contribute to seal putting ability.

Further, by increasing void fraction in a thermally sensitive recording layer, a pseudo layer of air protects permeation of water, further said chain structure entangles properly and becomes more insoluble in water so that higher water resistance is provided.

As a chain colloidal silica to be used in the present invention, a chain colloidal silica disclosed in an international publication WO00/15552 is desirable. That is, this product is consisting of spherical colloidal silica particles of average particle size 10-80 nm and metal oxide containing silica which bond said spherical colloidal silica particles, and D1/D2, which is the ratio of particle size (D1 nm) measured by dynamic light scattering method and average particle size of spherical colloidal silica D2 nm (measured particle size D2 nm by nitrogen absorbing method (BET method)), is 3 or more, wherein said D1 is 50-500 nm and it is desirable to use a dispersion of chain colloidal silica particles characterizing spherical colloidal silica particles are linked in one plane are dispersed in liquid medium and forms stable silica sol of 1-50 wt % SiO₂ concentration.

Said chain colloidal silica can be obtained by following (a), (b), (c) and (d) processes.

Colloidal aqueous solution of activated silicic acid used in (a) process is a solution in which silicic acid and polymer particles of silicic acid whose particle size is 3 nm or less are coexisting and can be prepared easily by a conventional method. Desirable aqueous colloidal solution of activated silicic acid can be obtained by cation exchange treatment of water soluble silicate, for example, diluted aqueous solution of water glass SiO₂/M₂O (wherein, M indicates alkali metal atom and O indicates oxygen atom) molar ratio is 2-4. And, in general, colloidal solution containing 0.5-5 wt % of solid and whose pH value is 6 or less, desirably 2-6 is used. Further, this pH value can be easily adjusted by partially remaining cations at cation exchange process of said aqueous solution of water glass, or after removing all or a part of cations, by adding small amount of alkali metal hydroxide or water soluble organic base to obtained colloidal aqueous solution of activated silicic acid. Since the colloidal aqueous solution of activated silicic acid is unstable and has a tendency to easily gelate, it is desirable to use immediately after preparation. As long as the aimed silica sol is obtainable, the colloidal aqueous solution of activated silicic acid can contain other components, further, can contain small amount of cation and anion. (a) Particle size of acidic silica sol having average particle size of 3-8 nm is difficult to be measured by a nitrogen absorbing method, and in general, SHIARS method is used.

According to a nitrogen absorbing method, silica sol is dried up and specific surface area is measured by a nitrogen absorbing method, however, when average particle size is small, since colloidal silica particles bonds each other and specific surface area becomes small, it becomes difficult to measure true value. SHIARS method is a SHIARS titration method disclosed in page 1981 of Analytical Chemistry vol. 28, No. 12 (1956), and true value can be measured because measured in liquid state.

This acidic silica sol whose average particle size is 3-8 nm, SiO₂ concentration is 0.5-10 wt % and pH is 2-6 can be a product prepared by a conventional method, for example, by methods disclosed in U.S. Pat. No. 268,071 B publication, U.S. Pat. No. 2,900,348 publication or JPH4-55127B publications, and when D1/D3 ratio, wherein D1 is measured particle size value by a dynamic light scattering method and D3 is measured particle size value by SHIARS method, is less than 5, the shape of the colloidal silica particles can be spherical or not spherical. However, for the purpose to obtain homogeneous chain silica sol, it is desirable to use a spherical silica sol having small particle size measured by a dynamic light scattering method. This acidic silica sol can be obtained by cation exchange process and pH value can be easily adjusted by partially remaining cations at cation exchange process of said aqueous solution of water glass, or after removing all or a part of cations, by adding small amount of alkali metal hydroxide or water soluble organic base to obtained colloidal aqueous solution of activated silicic acid. As said acidic silica sol, product in the market can be used.

In (a) process, to the colloidal aqueous solution of activated silicate whose pH is 2-6 or to the acidic silica sol whose average particle size is 3-8 nm, a water soluble metal salt of II valent or III valent metal can be added by alone or as a mixture, desirably as a water solution thereof. The amount of a salt of metal of II valent or III valent to be added is the amount to be 1-10 wt % to SiO₂ in said colloidal aqueous solution of activated silicate or in acidic silica sol as a metal oxide (in a case of metal salt of II valent metal is MO, in a case of metal salt of II valent metal is M₂O₃, wherein, M indicates a metal atom of II valent or III valent, and O indicates oxygen atom). And, this adding process is desirable to be carried out under stirring, and mixing temperature and time are not restricted, however, it is preferable to be 2-50° C. and from 5 minutes to 1 hour. As the metal salts of II valent or III valent salt to be added, inorganic acid salt or organic acid salt such as chloride, nitrate, sulfate, sulfamate, formate or acetate of Ca, Mg, Sr, Ba, Zn, Sn, Pb, Ni, Co, Fe, Al, In, Y or Ti can be mentioned.

In (b) process, acidic spherical silica sol of average particle size 10-80 nm and pH 2-6 is added to a mixture (a) obtained by above (a) process. The acidic spherical silica sol of average particle size (particle size D2 nm measured by a nitrogen absorption method) is 10-80 nm, pH is 2-6 can be a product prepared by a conventional method using water glass or alkyl silicate as a starting material or can be a product which is sold on the market as an industrial material. In a case when a silica sol on the market is alkaline, it is possible to obtain an acidic silica sol easily by cation exchange process of the alkaline silica sol on the market. A silica sol whose SiO₂ concentration is 10-50 wt % can be used. Ratio of D1, which is the measured particle size by a dynamic light scattering method, to D2, that is, D1/D2 value of the silica sol is generally less than 2, and it is desirable to use the silica sol whose D1/D2 ratio is smaller. Addition of said silica sol is desirable to be carried out immediately after (a) process under stirring. And mixing temperature and time are not restricted, however, it is preferable to be 2-50° C. and from 5 minutes to 1 hour.

Amount of acidic spherical silica sol having 10-80 nm average particle size to be added at process (b) is the amount that the ratio A/B (by weight) of silica content (A) originated to acidic spherical silica sol, and silica content (B) originated to a mixture (a) obtained by (a) process is 5-100, and total silica content (A+B) in a mixture (b) obtained by (b) process becomes 5-40 wt % as SiO₂ concentration.

In (c) process, alkali metal hydroxide, water soluble organic base or water soluble silicate are added to a mixture (b) obtained by above mentioned (b) process. This addition process may be carried out immediately after (b) process under stirring. And mixing temperature and time are not restricted, however, it is preferable to be 2-50° C. and from 5 minutes to 1 hour. It is desirable that the alkali metal hydroxide, water soluble organic base or water soluble silicate to be added are mixed homogeneously together with a liquid obtained in (b) process. As an alkali metal hydroxide, for example, hydroxide of sodium, potassium or lithium can be mentioned. As a water soluble organic base, quaternary ammonium hydroxides such as tetraethanolammonium hydroxide, monomethyl triethanolammonium hydroxide or tetramethylammonium hydroxide, amines such as monoethanolamine, diethanolamine, triethanolamine, piperazine or morpholine can be mentioned. Further, as a water soluble silicate, sodium silicate, potassium silicate or quaternary ammonium silicate consisting of base component of said quaternary ammonium hydroxide can be mentioned as an example. These alkali metal hydroxide, water soluble organic base and water soluble silicate can be used by mixing.

In (c) process, adding amount of said alkali metal hydroxide, water soluble organic base and water soluble silicate are the amount to make a pH of mixture (c) obtained by (c) process to be 7-11. When an alkali metal atom of the alkali metal hydroxide or a molecular of the organic base is indicated by M, amount of the alkali metal, organic base or water soluble silicate to be added are the amount to make the amount of alkali metal of organic base in an liquid obtained by (c) process to silica content in mixture (c) obtained by (c) process to be 50-800 by SiO₂/M₂O molar ratio.

In (d) process, a mixture (c) obtained by above (c) process is heated. This heating process is carried out at 100-200° C., and 0.5-50 hours heating time is needed. Further, this heating is desirable to be carried out by stirring said liquid, and is desirable to be carried out in the condition that vaporization of water does not occur.

At the heating of the mixture (c), required power for stirring per unit volume is 0.01-5 kW/m³. Especially, when the required power per unit volume is adjusted to 0.01-10 kW/m³, formation of wet silica gel in silica sol can be oppressed.

By this heating, spherical colloidal silica particle (particle size D2) and silica which connect said spherical colloidal silica particle is bonded by dehydration polycondensation reaction and connected in one plane, and chain colloidal silica particles of particle size (D1) measured by dynamic light scattering method is 50-500 nm and D1/D2 value is 3 or more are formed.

Therefore, obtained liquid is silica sol and SiO₂ concentration is generally 5-40 wt %, and when the concentration is too low, it is possible to condensate it. At the condensation, it is desirable to remove anions from silica sol obtained in (d) process existing by amount which disturbs the stabilization of silica sol when exist in concentrated silica sol. For the removal of anions, a method which uses fine porous membrane such as ultrafilter membrane or reverse osmosis membrane or a method to use ion-exchange resin can be mentioned. PH of silica sol obtained by (d) process or silica sol after condensation can be adjusted voluntarily by adding alkali.

Silica sol obtained by above mentioned (d) process or the silica sol from which adequate amount of anions or anions and water is characterized to be SiO₂ concentration is 10-50 wt %, having several mPa·s −1000 mPa·s viscosity and indicating 8-11 of pH at room temperature. In the present invention, pH is desirably 6 or more. In this silica sol, although 100-2000 p.p.m. of anions are contained, this silica sol is very stable. And this silica sol contains alkali metal ions and organic base by amount so that SiO₂/M₂O (wherein, M indicates alkali metal atom or organic base and O indicates oxygen atom) molar ratio becomes 50-800, further, 100-10000 p.p.m. of a metal of II valent or III valent is contained by amount converted to metal oxide to SiO₂.

And, colloidal silica particle of this silica sol maintains the shape and size formed by said (d) process and contains metal oxide of II valent or III valent which are existing in said silica sol. Chemical analysis of them can be easily carried out by an ordinary method. The particle size by a dynamic light scattering method of this colloidal silica particle can be easily measured by an apparatus which is on the market, and is 50-500 nm.

Further, in the present invention, from the view point of water resisting property, complex particles prepared by introducing colloidal silica into acrylic polymer components can be usable, however, it is desirable that acrylic polymer and colloidal silica are respectively used and contained. The reason why is not clear, however, it is considered that depending on the bonding condition of acrylic polymer and colloidal silica. That is, in a case of complex particles type, colloidal silica surrounding an acryl particle are strongly bonded by polymerization bond, and when is used as a binder for a thermally sensitive layer, fusing or contacting of acryl particles each other become difficult by the presence of collodal silica and film forming ability is obstructed. On the contrary, when acryl particles and colloidal silica are simply added, colloidal silica combined with acryl particles weakly by adsorption and does not obstruct film formation caused by acryl particles each other, thus a strong film is formed so that water resisting property is further improved. Furthermore, by good film forming ability, strength of a thermally sensitive recording layer is improved and a printing aptitude is also improved.

As an acryl polymer used in the present invention, it is desirable to use a polymer obtained by copolymerization using alkyl acrylate, alkyl methacrylate or vinyl silane as a necessary monomer component, and when need is arisen, an emulsifier can be used so as to use as an aqueous emulsion which contains said copolymer.

Among a monomer which is a component composing the acryl polymer, alkyl acrylate is specified to an alkyl acrylate having alkyl group of carbon number 1-10 and specifically, methyl acrylate, ethyl acrylate, propyl acrylate, butyl acrylate, octyl acrylate, 2-ethylhexyl acrylate or 2-hydroxyethyl acrylate can be mentioned. Especially, butyl acrylate is desirable.

Alkyl methacrylate is specified to an alkyl methacrylate having alkyl group of carbon number 1-10 and specifically, methyl methacrylate, ethyl methacrylate, butyl methacrylate, 2-ethylhexyl methacrylate or 2-hydroxyethyl methacrylate can be mentioned. Especially, methyl methacrylate is desirable.

As a specific example of vinyl silane, vinyltrimethoxysilane, vinyltriethoxysilane, vinyltris(2-methoxyethoxy)silane, vinyltriacetoxy silane, γ-methacryloxypropyltrimethoxysilane, vinyltrichlorosilane or γ-methacryloxypropyltris(methoxyethoxy)silane can be mentioned. Among these compounds, vinyltrimethoxysilane is especially desirable.

Further, as the other monomer which can be copolymerized with these mentioned monomers, styrene, N-methylolacrylamide, acrylic acid, methacrylic acid, itaconic acid, acrylamide, acrylonitrile, vinyl acetate or vinyl ester of saturated carboxylic acid can be mentioned. Especially, for the purpose to form a film having high strength, it is desirable to contain acrylonitrile or styrene partially. And, by using these compounds, good water resisting property and good printing aptitude can be obtained.

Regarding blending ratio of above mentioned monomers, blending ratio of alkyl acrylate to alkyl methacrylate is 10-900 weight parts of alkyl methacrylate to 100 weight parts of alkyl acrylate, desirably 20-500 weight parts. Blending ratio of vinyl silane is 0.5-10 weight parts to 100 weight parts of total alkyl acrylate and alkyl methacrylate, desirably 1-5 weight parts. Further, blending ratio of other monomers is 10-900 weight parts to 100 weight parts of total alkyl acrylate and alkyl methacrylate, desirably 20-500 weight parts.

By emulsion polymerization of these monomers under the presence of a polymerization initiator or an emulsifier, copolymer can be obtained. As a method for polymerization, there is no limitation for a method of monomer feeding, and lump together method, batch method or continuous feeding method can be used. Further, a method to polymerize a part previously then to feed remaining part continuously can be used. Regarding a polymerization initiator and an emulsifier are not specifically restricted, and ordinary ones can be used. For Example, alkali metal salt of fatty acid, alkali metal alkylether carboxylate, alkali metal alkylbenzensulfonate, alkali metal alkylnaphthalenesulfonate, alkali metal alkylsulfoacetate, alkali metal α-olefinsulfonate, alkali metal higher alcohol sulfonate, alkali metal alkylether sulfonate, alkali metal polyoxyethylenealkylphenylether sulfonate, polyoxyethylenealkylether, polyoxyethylenealkylphenylether, polyoxyethylenesorbitane fatty acid ester, polyoxyethylenesorbitol fatty acid ester or polyoxyethyleneglycol fatty acid ester can be used.

In particular, a polymerizable emulsifier, which is a reactive monomer having a characteristic of emulsifier, is desirable. When an ordinary emulsifier is used, since the ordinary emulsifier is ionicity and remaining emulsifier acts as a catalyst for chemical reaction of a dye and a color developing agent and has perilousness to develop color of a coating for thermally sensitive recording layer. On the contrary, when a polymerizable emulsifier, which is a reactive monomer having a characteristic of emulsifier, is used, since the emulsifier is introduced into acryl polymer, it does not affect a coating for thermally sensitive recording layer. As a polymerizable emulsifier, any kinds emulsifier providing with above mentioned property can be used and not restricted, and specifically, alkali salt of alkylallylsulfosuccinate, sodium(glycerin-n-alkenylsuccino-ir-glycerin)borate, alkali salt of sulfopropylmaleic acid mono alkyl ester or polyoxyethylenealkyl ester of acrylic acid or methacrylic acid can be mentioned as a desirable example. The amount to be used is desirably 0.5 to 10 weight parts to 100 weight parts of total alkyl acrylate and alkyl methacrylate.

As the desirable blending amount of acryl polymer is 0.1-50 weight parts to 100 parts (hereinafter, weight parts is a converted amount to solid) of thermally sensitive recording layer, more desirably is 0.1-30 weight parts. When the amount is too small, lacks water resisting property, while the amount is too much, causes deterioration of sensitivity. Desirable blending amount of colloidal silica is 1-500 weight parts to 100 parts of acrylic emulsion, more desirably is 10-300 weight parts. When the amount of colloidal silica is too small, adhesion of dregs on a head or sticking are caused, while the amount is too much, stability of a coating of thermally sensitive recording layer by time lapse becomes a problem.

When further high water resisting property is required, a thermally sensitive recording layer containing an acryl polymer, a colloidal silica and a cross linking agent is provided, then the thermally sensitive recording layer may be heat treated in temperature condition higher than 30° C. and lower than 60° C. for 24 hours.

As a color developing agent to be used in the present invention, any kinds of color developing agent which are public known in fields of pressure sensitive of thermally sensitive recording medium can be used and not restricted, and for example, inorganic acidic compound such as activated clay, attapulgite, colloidal silica or aluminum silicate, 4,4′-isopropyldiphenol, 1,1-bis(4-hydroxyphenyl)cyclohexane, 2,2-bis(4-hydroxyphenyl)-4-methylpentane, 4,4′-dihydroxydiphenylsulfide, hydroquinonemonobenzylether, 4-hydroxybenzylbenzoate, 4,4′-dihydroxydiphenylsulfone, 2,4′-dihydroxydiphenylsulfone, 4-hydroxy-4′-isopropoxydiphenylsulfone, 4-hydroxy-4′-n-isopropoxydiphenylsulfone, bis(4-allyl-4-hydroxyphenyl)sulfone, 4-hydroxy-4′-methyldiphenylsulfone, 4-hydroxyphenyl-4′-benzyloxyphenylsulfone, 3,4-dihydroxyphenyl-4′-methylphenylsulfone, aminobenzenesulfoamide derivatives disclosed in JPH8-59603 A publication, bis(4-hydroxyphenylthioethoxy)methane, 1,5-di(4-hydroxyphenylthio)-3-oxapentane, bis(p-hydroxyphenyl)butylacetate, bis(p-hydroxyphenyl)methylacetate, 1,1-bis(4-hydroxyphenyl)-1-phenylethane, 1,4-bis[α-methyl-α-(4′-hydroxyphenyl)ethyl]benzene, 1,3-bis[α-methyl-α-(4′-hydroxyphenyl)ethyl]benzene, di(4-hydroxy-3-methylphenyl)sulfide, 2,2′-thiobis(3-tert-octylphenol), 2,2′-thiobis(4-tert-octylphenol), phenolic compound such as diphenylsulfone crosslinked compound disclosed in WO97/16420 International Publication, compound disclosed in WO02/081229 International Publication or JP2002-301873 A publication, thiourea compound such as N,N′-di-m-chlorophenylthiourea, thiourea compounds such as N,N′-di-m-chlorophenylthiourea, p-chlorobenzoic acid, stearyl gallate, bis[4-(n-octyloxycabonylamino)zincsalicylate]di-hydrate, aromatic carboxylic acid such as 4-[2-(p-methoxyphenoxy)ethyloxylsalicylic acid, 4-[3-(p-tolylsulfonyl)propyloxy]salicylic acid or 5-[p-(2-p-p-methoxyphenoxyethoxycumyl)salicylic acid, and salt of these aromatic acids with divalent metal such as zinc, magnesium, aluminium, calcium, titanium, manganese, thin or nickel, antipyrine complex of zinc thiocyanate, complex zinc salt of terephthalaldehydic and other aromatic carboxylic acid can be mentioned. These sensitizers can be used alone or together with. Especially, dihydroxysulfone compound, diphenylsulfone crosslinked compound disclosed in WO97/16420 International Publication or 4-hydroxy-4′-n-propoxydiphenylsulfone are desirably used, and diphenylsulfone crosslinked compound can be purchased as commodity name D-90 of Nihon Soda Co., ltd. Further, a compound disclosed in WO02/081229 International Publication can be purchased as commodity name D-100 of Nihon Soda Co., ltd. Still further, it is possible to contain metal chelete color developing component such as higher fatty acid metal complex salt disclosed in JP H10-258577 A publication or divalent hydroxyl aromatic compounds.

As a basic leuco dye used in the present invention, any kinds of dye which are public known in fields of pressure sensitive of thermally sensitive recording medium can be used and not restricted, and for example, triphenylmethane compounds, fluorane, fluorene or divinyl compounds are desirably used. Examples of specific colorless or pale colored dye (dye precursor) are shown as follows. These dye precursors can be used alone or together with.

<Triphenyl Methane Leuco Dye>

3,3′-bis(4-aminophenyl)-6-dimethylaminophthalide [another name; Crystal Violet Lacton],
3,3-bis(p-dimethylaminophenyl)phthalide [another name is Malachite Green Lactone]
   <Fluorane Leuco Dyes>
3-diethylamino-6-methylfluorane
3-diethylamino-6-methyl-7-anilinofluorane
3-diethylamino-6-methyl-7-(o,p-dimethylanilino)fluorane
3-diethylamino-6-methyl-7-chlorofluorane
3-diethylamino-6-methyl-7-(m-trifluoromethylanilino)fluorane
3-diethylamino-6-methyl-7-(o-chloroanilino)fluorane
3-diethylamino-6-methyl-7-(p -chloroanilino)fluorane
3-diethylamino-6-methyl-7-(o-fluoroanilino)fluorane
3-diethylamino-6-methyl-7-(m-methylanilino)fluorane
3-diethylamino-6-methyl-7-n-octylanilinofluorane
3-diethylamino-6-methyl-7-n-octylaminofluorane
3-diethylamino-6-methyl-7-benzylanilinofluorane
3-diethylamino-6-methyl-7-dibenzylanilinofluorane
3-diethylamino-6-chloro-7-methylfluorane
3-diethylamino-6-chloro-7-anilinofluorane
3-diethylamino-6-chloro-7-p-methylanilinofluorane
3-diethylamino-6-ethoxyethyl-7-anilinofluorane
3-diethylamino-7-methylfluorane
3-diethylamino-7-chlorofluorane
3-diethylamino-7-(m-trifluoromethylanilino)fluorane
3-diethylamino-7-(o-chloroanilino)fluorane
3-diethylamino-7-(p -chloroanilino)fluorane
3-diethylamino-7-(o-fluoroanilino)fluorane
3-diethylamino-benzo[a]fluorane
3-diethylamino-benzo[c]fluorane
3-dibutylamino-6-methyl-fluorane
3-dibutylamino-6-methyl-7-anilinofluorane
3-dibutylamino-6-methyl-7-(o,p-dimethylanilino)fluorane
3-dibutylamino-6-methyl-7-(o-chloroanilino)fluorane
3-dibutylamino-6-methyl-7-(p-chloroanilino)fluorane
3-dibutylamino-6-methyl-7-(o-fluoroanilino)fluorane
3-dibutylamino-6-methyl-7-(m-trifluoromethylanilino)fluorane
3-dibutylamino-6-methyl-chlorofluorane
3-dibutylamino-6-ethoxyethyl-7-anilinofluorane
3-dibutylamino-6-chloro-7-anilinofluorane
3-dibutylamino-6-methyl-7-p-methylanilinofluorane
3-dibutylamino-7-(o-chloroanilino)fluorane
3-dibutylamino-7-(o-fluoroanilino)fluorane
3-di-n-pentylamino-6-methyl-7-anilinofluorane
3-di-n-pentylamino-6-methyl-7-(p-chloroanilino)fluorane
3-di-n-pentylamino-7-(m-trifluoromethylaniliono)fluorane
3-di-n-pentylamino-6-chloro-7-anilinofluorane
3-di-n-pentylamino-7-(p-chloroanilino)fluorane
3-pyrrolidino-6-methyl-7-anilinofluorane
3-piperidino-6-methyl-7-anilinofluorane
3-(N-methyl-N-propylamino)-6-methyl-7-anilinofluorane
3-(N-methyl-N-cyclohexylamino)-6-methyl-7-anilinofluorane
3-(N-ethyl-N-cyclohexylamino)-6-methyl-7-anilinofluorane
3-(N-ethyl-N-xylamino)-6-methyl-7-(p-chloroanilino)fluorane
3-(N-ethyl-p-toluidino)-6-methyl-7-anilinofluorane
3-(N-ethyl-N-isoamylamino)-6-methyl-7-anilinofluorane
3-(N-ethyl-N-isoamylamino)-6-chloro-7-anilinofluorane
3-(N-ethyl-N-tetrahydrofurfurylamino)-6-methyl-7-anilinofluorane
3-(N-ethyl-N-isobutylamino)-6-methyl-7-anilinofluorane
3-(N-ethyl-N-ethoxypropylamino)-6-methyl-7-anilinofluorane
3-cyclohexylamino-6-chlorofluorane
2-(4-oxahexyl)-3-dimethylamino-6-methyl-7-anilinofluorane
2-(4-oxahexyl)-3-diethylamino-6-methyl-7-anilinofluorane
2-(4-oxahexyl)-3-dipropylamino-6-methyl-7-anilinofluorane
2-methyl-6-p-(p-dimethylaminophenyl)aminoanilinofluorane
2-methoxy-6-p-(p-dimethylaminophenyl)aminoanilinofluorane
2-chloro-3-methyl-6-p-(p-phenylaminophenyl)aminoanlinofluorane
2-chloro-6-p-(p-dimethylaminophenyl)aminoanilinofluorane
2-nitro-6-p-(p-diethylaminophenyl)aminoanilinofluorane
2-amino-6-p-(p-diethylaminophenyl)aminoanilinofluorane
2-diethylamino-6-p-(p-diethylaminophenyl)aminoanilinofluorane
2-phenyl-6-methyl-6-p-(p-phenylaminophenyl)aminoanilinofluorane
2-benzyl-6-p-(p-phenylaminophenyl)aminoanilinofluorane
2-hydroxy-6-p-(p-phenylaminophenyl)aminoanilinofluorane
3-methyl-6-p-(p-dimethylaminophenyl)aminoaniinofluorane
3-diethylamino-6-p-(p-diethylaminophenyl)aminoanilinofluorane
3-diethylamino-6-p-(p-dibutylaminophenyl)aminoanilinofluorane
2,4-dimethyl-6-[(4-dimethylamino)anilino]-fluorane
   <Fluorene Leuco Dyes>
3,6,6′-tris(dimethylamino)spiro[fluorene-9,3′-phthalide]
3,6,6′-tris(diethylamino)spiro[fluorene-9,3′-phthalide]
   <Divinyl Leuco Dyes>
3,3-bis-[2-(p-dimethylaminophenyl)-2-(p-methoxyphenyl)ethenyl]-4,5,6,7-tetrabromo phthalide
3,3-bis-[2-(p-dimethylaminophenyl)-2-(p-methoxyphenyl)ethenyl]-4,5,6,7-tetrachloro phthalide
3,3-bis-[1,1-bis(4-pyrrolidinophenyl)ethylene-2-yl]-4,5,6,7-tetrabromophthalide
3,3-bis-[1-(4-methoxyphenyl)-1-(4-pyrrolidinophenyl)ethylene-2-yl]-4,5,6,7-tetra chlorophthalide
   <Others>
3-(4-diethylamino-2-ethoxyphenyl)-3-(1-ethyl-2-methyhndol-3-yl)-4-azaphthalide
3-(4-diethylamino-2-ethoxyphenyl)-3-(1-octyl-2-methylindol-3-yl)-4-azaphthalide
3-(4-cyclohexylethylamino-2-methoxyphenyl)-3-(1-ethyl-2-methylindol-3-yl)-4-azaphthalide
3,3-bis(1-ethyl-2-methylindol-3-yl)phthalide
3,6-bis(diethylamino)fluorane-γ-(3′-nitro)anilinolactam
3,6-bis(diethylamino)fluorane-γ-(4′-nitro)anilinolactam
1,1-bis-[2′,2′,2″,2″-tetrakis-(p-dimethylaminophenyl)-ethenyl]-2,2-dinitrilethane
1,1-bis-[2′,2′,2″, 2″-tetrakis-(p-dimethylaminophenyl)-ethenyl]-β-naphthoylethane
1,1-bis-[2′,2′,2″,2″-tetrakis-(p-dimethylaminophenyl)-ethenyl]-2,2-diacetylethane
bis-[2,2,2′,2′-tetrakis-(p-dimethylaminophenyl)-ethenyl]-methylmalonic acid dimethyl ester.

In the present invention, as an adhesive contained in a thermally sensitive recording layer, namely so called as a binder, above mentioned acryl polymer and colloidal silica are mainly used, however, for the purpose to improve fluidity of a coating, public known adhesive for a thermally sensitive recording layer can be used in the range not to affect the desired effect of the present invention can be used. Specifically, completely saponified polyvinyl alcohol having a degree of polymerization of 200 to 1,900, partially saponified polyvinyl alcohol, carboxy-modified polyvinyl alcohol, amide-modified polyvinyl alcohol, sulfonic acid-modified polyvinyl alcohol, butyral-modified polyvinyl alcohol and other modified polyvinyl alcohol, cellulose derivatives such as hydroxyethylcellulose, methylcellulose, carboxymethylcellulose, ethylcellulose or acetylcellulose, a styrene-maleic anhydride copolymer, styrene-butadiene copolymer, a cellulose derivative such as ethylcellulose or acetylcellulose, polyvinyl chloride, polyvinyl acetate, polyacrylamide, polyacrylate, polyvinyl butyral, polystyrene and a copolymer thereof, polyamide resin, silicon resin, petroleum resin, terpene resin, ketone resin and cumarone resin. When partially saponified polyvinyl alcohol whose saponified degree is smaller than 95%, a strong film is formed so that water resisting property and printing aptitude are improved and desirable. Those high molecular weight substances can be used by dissolving in a solvent such as water, alcohol, ketone, ester or hydrocarbon or emulsifying or dispersing as a paste in water or another medium, and can be used together with according to required quality.

Further, in the present invention, conventional sensitizer can be used in the range not obstructing the desired effect regarding above mentioned object of the present invention. As the specific example of the sensitizer, ethylenebisamide, montan wax, polyethylene wax, 1,2-di(3-methylphenoxy)ethane, p-benzylbiphenyl, β-benzyloxynaphthalene, 4-biphenyl-p-tolyl ether, m-terphenyl, 1,2-diphenoxyethane, 4,4′-ethylenedioxy-bis-dibenzyl benzoate, dibenzoyloxymethane, 1,2-di(3-methylphenoxy)ethylene, 1,2-diphenoxyethylene, bis[2-(4-methoxy-phenoxy)ethyl]ether, methyl p-nitrobenzoate, dibenzyloxalate, di(p-chlorobenzyl)oxalate, di(p-mrthylbenzyl)oxalate, dibenzylterephthalate, benzyl p-benzyloxybenzoate, di-p-tolylcarbonate, phenyl-α-naphythylcarbonate, 1,4-diethoxynaphthalene, phenyl 1-hydroxy-2-naphthoate, 4-(m-methylphenoxymethyl)biphenyl, orthotoluenesulfonamide and paratoluenesulfonamide, however, not intending to be limited to these compounds. These sensitizers can be used alone or can be used together with.

As a filler to be used in the present invention, an inorganic filler such as silica, calcium carbonate, kaolin, calcined kaolin, diatomaceous earth, talk, titanium oxide or aluminum hydroxide or an organic filler can be mentioned. In particular, titanium oxide of average particle size 8-15 μm is desirable, because it effectively prevents accumulation of dregs on a head and sticking. When silica of more than 100 ml/100 g (JIS K5101) oil absorbing ability, less than 150 m²/g BET specific surface area and smaller than 5 μm average particle size is contained, voids are formed in a thermally sensitive recording layer and it is considered that fused subject is absorbed in the voids so that the formation of dregs on a head is prevented, therefore, said silica is desirably used. Besides these compounds, a slipping agent such as waxes, an Ultra Violet ray absorbing agent such as benzo-phenons or triazols, a water resisting agent such as glyoxal, a dispersing agent, a defoaming agent, an antioxidant or a fluorescent dye can be used.

Furthermore, in the present invention, a stabilizer which displays oil repellent effect to the recorded image can be used in the range not obstructing the desired effect regarding above mentioned object of the present invention. As the specific example of the stabilizer, 4,4′-buthylidenebis(6-t-butyl-3-methylphenol), 2,2′-di-t-butyl-5,5′-dimethyl-4,4′-sulphonyldiphenyl, 1,1,3-tris(2-methyl-4-hydroxy-5-cyclohexylphenyl)butane, 1,1,3-tris(2-methyl-4-hydroxy-5-t-butylphenyl)butane, 4-benzyloxy-4′-(2,3-epoxy-2-methylpropoxy)diphenylsulfone or epoxy resin can be added.

The kinds and amount of basic leuco dye, color developing agent and other components which are used in the thermally sensitive recording medium of the present invention, are decided according to the required properties and recording suitability and not restricted, however, ordinary, 0.5 to 10 parts of color developing agent and 0.5 to 10 parts of filler to 1 part of basic leuco dye is used.

The subjected thermally sensitive recording medium can be obtained by applying the coating composed of above mentioned composition on a substrate such as paper, recycled paper, synthetic paper, film, plastic film, plastic foam film or non-woven cloth. And a composite sheet which is prepared by combining these substrates can be used as a substrate. In a case when excellent water resisting ability is required, it is possible to use a paper whose Bekk smoothness after water coated is more than 30 sec. can be used as a substrate. And, wet paper strength of paper is improved by adding a wet paper strength enhancing agent can be added, further, a neutral paper is desirably used than an acidic paper.

Basic leuco dye, color developing agent and other materials to be added by necessity are pulverized by a ball mill, an attriter or a sand grinder, or by means of an adequate emulsifying apparatus, until they are pulverized under several micron size, then add acrylic emulsion, colloidal silica and various additives according to the object and prepare a coating. The means for coating is not restricted and public known conventional methods can be used, and specifically, for example, an off machine coater with various coater such as air knife coater, rod blade coater, bill blade coater or roll coater or an on machine coater can be voluntarily chosen and used. The coating amount for a thermally sensitive layer is not specifically restricted, and in general, is in the range from 2 to 12 g/m² by dry weight.

Still further, the thermally sensitive recording medium of the present invention can provide an over coating layer consisting of polymer on the thermally sensitive recording layer aiming to improve preserve ability and can provide an under coating layer consisting of polymer containing a filler under the thermally sensitive recording layer aiming to improve the color developing sensitivity. And can provide a back coating layer on the opposite side of the substrate to which the thermally sensitive recording is provided, for the purpose to correct the curling of the sheet. Yet further, various public known techniques in the field of the thermally sensitive recording medium can be added voluntarily, for example, to carry out a smoothness treatment such as a super calendar treatment after coating process of each layer.

### EXAMPLE

The thermally sensitive recording medium of the present invention will be illustrated more actually according to the Examples. In illustration, “parts” and “%⇄ indicates “weight parts” and “weight %”.

Following evaluation tests are carried out on specimens of thermally sensitive recording media obtained in Examples and Comparative Examples.

[Color Developing Sensitivity]

The produced thermally sensitive recording medium was subjected to printing at an applied energy of 0.25 mJ/dot and 0.34 mJ/dot by using TH-PMD (manufactured by Okura Denki). Image densities are measured by using a Macbeth Densitometer (using an amber filter).
   [Water Resistance]
One water drop is dropped on the surface of a thermally sensitive layer, after 10 minutes time lapse, scrubbed by a tissue paper, and removing of a recording surface is measured by eyes of an operator and evaluated by following standard.
◯: removal in a recorded surface is not observed
Δ: removal of recorded surface is observed slightly.
x: many removals are observed
   [Printing Aptitude]
RI printing is carried out on the surface of a thermally sensitive recording medium by UV ink and coming off of ink is measured by eyes of an operator and evaluated by following standard.
◯: coming off of ink is not observed
Δ: coming off of ink is observed slightly
x: many coming off of ink are observed
   [Dregs on a Head]
The produced thermally sensitive recording medium was subjected to printing at an applied energy of 0.34 mJ/dot by using TH-PMD of Okura Denki, and dregs on a head is measured and evaluated by following standard.
◯: dregs on a head is not observed
Δ: dregs on a head is observed slightly
x: dregs on a head are observed

### Synthesis Example 1

Aqueous solution of sodium silicate whose SiO₂ concentration is 3.6 weight % is obtained by adding DI water to water glass of JIS class 3 on the market (SiO₂/Na₂O molar ratio 3.22, SiO₂ concentration; 28.5 weight %). Said aqueous solution of sodium silicate is passed though a column in which cation-exchange resin, commodity name Umberlight 120B is filled up, and aqueous colloidal solution of activated silicic acid whose SiO₂ concentration is 3.60 weight %, pH is 2.90 and electric conductivity is 580 μ S/cm is obtained. 888 g of the obtained aqueous colloidal solution of activated silicic acid (SiO₂ content is 32.0 g) is poured into a glass container and 600 g of DI water is added under stirring, and aqueous colloidal solution of activated silicic acid, whose SiO₂ concentration is 2.15 weight % and pH is 3.07, is obtained. Then 59 g of 10 wt % calcium nitrate aqueous solution (pH 4.32) (CaO content 2.02 g) is added to the colloidal aqueous solution by stirring at room temperature and stirring is continued for 30 minutes. The added calcium nitrate is 6.30 wt % to SiO₂ as CaO.

While, 2000 g of acidic spherical silica sol of Snow Tex 0-40 (product of Nissan Kagaku Kogyo Co., Ltd.) (specific gravity; 1.289, viscosity; 4.10 mPa·s, pH; 2.67, electric conductivity; 942 μS/cm, SiO₂ concentration; 40.1 weight %) (SiO₂ content. 802 g), whose average particle size (by nitrogen absorbing method/D2) is 20.5 nm, is poured into another glass container, then 6.0 g of 5 wt % aqueous solution of sodium hydroxide is added to said glass container by stirring, and stirring is continued for 30 minutes, thus acidic silica sol whose pH is 4.73, SiO₂ concentration is 40.0 wt % is obtained.

Measured particle size by dynamic light scattering method of this silica sol (D1) is 35.0 nm and D1/D2 value is 1.71. According to an electric microscopic observation, shape of colloidal silica particle in this silica sol is spherical and dispersion state is closely like as monodispersion, and bonding between particles and flocculation are not observed.

This acidic spherical silica sol of 20.5 nm is added to afore mentioned colloidal aqueous solution of activated silicate to which calcium nitrate is added [mixture (a)] and stirred for 30 minutes.

Obtained mixture (b) is characterized that the ratio A/B (by weight) of silica content (A) originated to acidic spherical silica sol and silica content (B) originated to colloidal aqueous solution of activated silicate [mixture (a)] is 25.1, pH is 3.60, electric conductivity is 2580 μS/cm and total silica content (A+B) in mixture (b) is 23.5 wt % as SiO₂ concentration. Calcium ion existing in the solution as CaO is 0.242 wt % to SiO₂.

Then, 330 g of 1.97 weight % aqueous solution of sodium hydroxide is added under stirring by 10 minutes, and stirring is continued for another 1 hour. Mixture (c) obtained by addition of the aqueous solution of sodium hydroxide indicates pH 9.2 and electric conductivity is 3266 μS/cm, and SiO₂ concentration is 21.5 wt %, molar ratio of SiO₂/Na₂O is 163.5. In this mixture (c), presence of small amount of silica gel is observed.

After that, 1800 g of above mentioned alkaline mixture (c) is poured into a stainless steel autoclave, heated at 145° C. under stirring for 3 hours, then cooled down and whole content of 1800 g is took out. Obtained liquid is silica sol of transparent colloidal color [chain silica sol A] of SiO₂ concentration; 21.5 wt %, molar ratio; SiO₂/Na₂O 200, pH; 9.62, specific gravity; 1.141, viscosity; 91.7 mPa·s, electric conductivity; 3290 μS/cm, transmittance; 59.0% and measured particle size by dynamic light scattering method (D1) is 177 nm. Therefore, D1/D2 ratio is 8.63.

### Synthesis Example 2

1800 g of alkaline mixture (c) obtained in Synthesis Example 1 is poured into a stainless steel autoclave, heated at 135° C. under stirring for 3 hours, then cooled down and whole content of 1800 g is took out. Obtained liquid is silica sol of transparent colloidal color [chain silica sol B] of SiO₂ concentration;. 21.5 wt %, pH; 9.56, specific gravity; 1.141, viscosity; 4.5 mPa·s, electric conductivity; 3285 μS/cm and measured particle size by dynamic light scattering method (D1) is 116 nm. Therefore, D1/D2 ratio is 5.66.

### Synthesis Example 3

151 g of acidic silica sol Snow Tex OXA (product of Nissan Kagaku Kogyo Co., Ltd.) (specific gravity; 1.062, viscosity; 1.2 mPa·s, pH; 2.90, electric conductivity; 370 μS/cm, SiO₂ concentration; 10.6 weight %) having 5.6 nm average particle size(SHIARS method/D3) (SiO₂ contents; 16.0 g) is poured into a glass container, add 593 g of DI water under stirring and acidic silica sol of SiO₂ concentration; 2.15 weight %, pH; 3.42 is obtained. Measured particle size (D1) of this silica sol measured by dynamic light scattering method is 14.4 nm and D1/D3 value is 2.57. After that, 31 g of 10 wt % calcium nitrate aqueous solution (pH 4.32) (CaO content 1.06 g) is added to the colloidal aqueous solution by stirring at room temperature and stirring is continued for 30 minutes. The added calcium nitrate is 6.63 wt % to SiO₂ as CaO.

While, 1000 g of acidic spherical silica sol of Snow Tex 0-40 (SiO₂ content; 401 g), whose average particle size (D2) is 20.5 nm, is poured into another glass container, then 3.0 g of 5 wt % aqueous solution of sodium hydroxide is added to the glass container by stirring, and stirring is continued for 30 minutes, thus acidic silica sol whose pH is 4.73, SiO₂ concentration is 40.0 wt % is obtained.

Said acidic silica sol of average particle size 20.5 nm is added to afore mentioned acidic silica sol of average particle size 5.0 nm to which calcium nitrate is added under stirring, and the stirring is continued another 30 minutes. Obtained mixture (b) is characterized that the ratio A/B (by weight) of silica content (A) originated to acidic spherical silica sol and silica content (B) originated to colloidal aqueous solution of activated silicate [mixture (a)] is 25.1, pH is 4.07, electric conductivity is 3050 μS/cm and total silica content (A+B) in mixture (b) is 23.5 wt % as SiO₂ concentration. Calcium ion in the solution as CaO is 0.254 wt % to SiO₂.

Then, 65 g of 5.0 weight % aqueous solution of sodium hydroxide is added to the obtained mixture (b) under stirring by 5 minutes and the stirring is continued another 1 hour. Mixture (c) obtained by addition of aqueous solution of sodium hydroxide indicates pH; 9.42, electric conductivity; 3820 μS/cm, SiO₂ concentration; 22.6 wt % and molar ratio SiO₂/Na₂O; 163.5. Presence of silica gel in this mixture (c) is not observed.

After that, 1800 g of above mentioned alkaline mixture (c) is poured into a stainless steel autoclave and heated at 140° C. under stirring for 3 hours. Then cooled down and whole content of 1800 g is taken out. Although small amount of silica gel is existing, the obtained liquid is a silica sol of transparent colloidal color indicating SiO₂ concentration; 22.6 wt %, pH; 9.57, specific gravity; 1.148, viscosity; 800 mPa·s, electric conductivity; 3650 μS/cm, transmittance; 56.9% and measured particle size by dynamic light scattering method (D1) is 194 nm. Therefore, D1/D2 ratio is 9.46.

### Synthesis Example 4

Colloidal aqueous solution of activated silicate of SiO₂ concentration; 3.60 wt %, pH; 2.91 and electric conductivity; 580 μS/cm mentioned in Synthesis Example 1 is used.

532 g of this colloidal aqueous solution of activated silicate (SiO₂ content; 19.2 g ) is poured into a glass container, 200 g of DI water is added by stirring and colloidal aqueous solution of activated silicate of SiO₂ concentration; 2.62 wt % and pH; 3.02 is obtained. Then, 35.4 g of 10 wt % aqueous solution of calcium nitrate (pH; 4.32) (CaO content; 1.21 g) is added by stirring at room temperature, and the stirring is continued another 30 minutes. Added calcium nitrate is 6.32 wt % as CaO to SiO₂.

1600 g of acidic spherical silica sol of Snow Tex OML (product of Nissan Kagaku Kogyo Co., Ltd.) (specific gravity; 1.404, viscosity; 12.7 mPa·s, pH; 2.15, electric conductivity; 2405 μS/cm, SiO₂ concentration; 50.0 weight %) (SiO₂ content; 800 g), is poured into another glass container, then 9.0 g of 5 wt % aqueous solution of sodium hydroxide is added to the glass container by stirring, and stirring is continued for 30 minutes, thus acidic silica sol whose pH is 5.04, SiO₂ concentration is 49.7 wt % is obtained. Measured particle size by dynamic light scattering method (D1) of Snow Tex OML is 54.4 nm, D1/D2 ratio is 1.47. To the colloidal solution of activated silicate to which calcium nitrate is added [mixture (a)], above mentioned acidic silica sol having 37.0 average particle size is added under stirring and stirring is continued another 30 minutes.

Obtained mixture (b) is characterized that the ratio A/B (by weight) of silica content (A) originated to acidic spherical silica sol and silica content (B) originated to colloidal aqueous solution of activated silicate [mixture (a)] is 42.1, pH is 4.03, electric conductivity is 2900 μS/cm and total silica content (A+B) in mixture (b) is 34.6 wt % as SiO₂ concentration. Calcium ion in the solution as CaO is 0.148 wt % to SiO₂.

Then, 40 g of 10 weight % aqueous solution of sodium hydroxide is added to the obtained mixture (b) under stirring by 5 minutes and the stirring is continued another 1 hour. Mixture obtained by addition of aqueous solution of sodium hydroxide indicates pH; 9.24, electric conductivity; 3920 μS/cm, SiO₂ concentration; 34.0 wt % and SiO₂/Na₂O molar ratio; 245. Presence of small amount of silica sol is observed in this mixture (c).

After that, 1800 g of above mentioned alkaline mixture (c) is poured into a stainless steel autoclave and heated at 150° C. under stirring for 3 hours. Then cooled down and whole content of 1800 g is taken out. Presence of silica gel is not detected in the obtained liquid, and the obtained liquid is a silica sol of transparent colloidal color indicating SiO₂ concentration; 34.0 wt %, pH; 9.54, specific gravity; 1.240, viscosity; 42.9 mPa·s, electric conductivity; 3685 μS/cm, transmittance; 24.1% and measured particle size by dynamic light scattering method (D1) is 155 nm. Therefore, D1/D2 ratio is 4.19.

### Synthesis Example 5

560 g of colloidal aqueous solution of activated silicate obtained in Synthesis Example 1 is poured into a glass container, 300 g of DI water is added by stirring and colloidal aqueous solution of activated silicate of SiO₂ concentration; 2.34 wt % and pH; 3.05 is obtained. Then, 37.2 g of 10 wt % aqueous solution of calcium nitrate (pH; 4.32) (CaO content; 1.27 g) is added by stirring at room temperature, and the stirring is continued another 30 minutes. Added calcium nitrate is 6.30 wt % as CaO to SiO₂.

While, 1440 g of acidic spherical silica sol of Snow Tex O (product of Nissan Kagaku Kogyo Co., Ltd.) (specific gravity; 1.126, viscosity; 1.7 mPa·s, pH; 2.70, electric conductivity; 390 μS/cm, SiO₂ concentration; 20.3 weight %, Al₂O₃ concentration; 430 p.p.m., Fe₂O₃ concentration; 7 p.p.m., CaO concentration; 2 p.p.m., MgO concentration; 3 p.p.m.) (SiO₂ content; 292 g) whose average particle size (by nitrogen absorption method/D2) is 12.3 nm, is poured into another glass container, then 3.0 g of 5 wt % aqueous solution of sodium hydroxide is added to the glass container by stirring, and stirring is continued for 30 minutes, thus acidic silica sol whose pH is 5.47, SiO₂ concentration is 20.2 wt % is obtained. Measured particle size by dynamic light scattering method (D1) of this silica sol is 19.4 nm, D1/D2 ratio is 1.62. According to electric microscope observation, shape of collidal silica particle in this silica sol is spherical and dispersion state is closely like as monodispersion, and bonding between particles and flocculation are not observed. To the colloidal solution of activated silicate to which calcium nitrate is added [mixture (a)], above mentioned acidic silica sol having 12.0 nm average particle size is added under stirring and stirring is continued for another 30 minutes.

Obtained mixture (b) is characterized that the ratio A/B (by weight) of silica content (A) originated to acidic spherical silica sol and silica content (B) originated to colloidal aqueous solution of activated silicate [mixture (a)] is 14.5, pH is 4.25, electric conductivity is 2600 μS/cm and total silica content (A+B) in mixture (b) is 13.3 wt % as SiO₂ concentration. Calcium ion in the solution as CaO is 0.407 wt % to SiO₂.

Then, 111 g of 5.0 weight % aqueous solution of sodium hydroxide is added to the obtained mixture (b) under stirring by 10 minutes and the stirring is continued another 1 hour. Mixture (c) obtained by addition of aqueous solution of sodium hydroxide indicates pH; 9.70, electric conductivity; 3605 μS/cm, SiO₂ concentration; 12.7 wt % and SiO₂/Na₂O molar ratio; 73.0. Presence of small amount of silica sol is observed in this mixture (c).

After that, 1800 g of above mentioned alkaline mixture (c) is poured into a stainless steel autoclave and heated at 130° C. under stirring for 3 hours. Then cooled down and whole content of 1800 g is taken out. Presence of silica gel is not detected in the obtained liquid, and the obtained liquid is a silica sol of transparent colloidal color indicating SiO₂ concentration; 12.7 wt %, pH; 10.03, specific gravity; 1.082, viscosity; 79.5 mPa·s, electric conductivity; 3635 μS/cm and measured particle size by dynamic light scattering method (D1) is 163 nm. Therefore, D1/D2 ratio is 13.6.

### Synthesis Example 6

346 g of colloidal aqueous solution of activated silicate obtained in Synthesis Example 1 (SiO₂ content; 12.5 g) is poured into a glass container, then 41.4 g of 10 wt % of aqueous solution of calcium nitrate (pH; 4.32) (CaO content; 1.41 g) is added under stirring at room temperature, and the stirring is continued another 30 minutes. Added calcium nitrate is 11.28 wt % as CaO to SiO₂.

While, 2063 g of acidic spherical silica sol of Snow Tex-O25 (product of Nissan Kagaku Kogyo Co., Ltd.) (specific gravity; 1.16, viscosity; 2.9 mPa·s, pH; 2.70, electric conductivity; 1020 μS/cm, SiO₂ concentration; 25.1 weight %) (SiO₂ content; 517.8 g), whose average particle size (by nitrogen absorption method/D2) is 12.0 nm, is poured into another glass container, then 8.0 g of 5 wt % aqueous solution of sodium hydroxide is added to the glass container by stirring, and stirring is continued for 30 minutes, thus acidic silica sol whose pH is 4.65, SiO₂ concentration is 25.0 wt % is obtained. Measured particle size by dynamic light scattering method (D1) of this silica sol is 20.5 nm, D1/D2 ratio is 1.71. According to electric microscope observation, shape of colloidal silica particle in this silica sol is spherical and dispersion state is closely like as monodispersion, and bonding between particles and flocculation are not observed. To the colloidal solution of activated silicate to which calcium nitrate is added [mixture (a)], above mentioned acidic silica sol having 12.0 nm average particle size is added under stirring and stirring is continued for 30 minutes.

Obtained mixture (b) is characterized that the ratio A/B (by weight) of silica content (A) originated to acidic spherical silica sol and silica content (B) originated to colloidal aqueous solution of activated silicate [mixture (a)] is 41.4, pH is 3.90, electric conductivity is 2600 μS/cm and total silica content (A+B) in mixture (b) is 21.6 wt % as SiO₂ concentration. Calcium ion in the solution as CaO is 0.267 wt % to SiO₂.

Then, 155 g of 5.0 weight % aqueous solution of sodium hydroxide is added to the obtained mixture (b) under stirring by 10 minutes and the stirring is continued another 1 hour. Mixture (c) obtained by addition of aqueous solution of sodium hydroxide indicates pH; 9.89, electric conductivity; 3940 μS/cm, SiO₂ concentration; 20.3 wt % and SiO₂/Na₂O molar ratio; 86.9. Presence of small amount of silica sol is observed in this mixture (c).

After that, 1800 g of above mentioned alkaline mixture (c) is poured into a stainless steel autoclave and heated at 138° C. under stirring for 5 hours. Then cooled down and whole content of 1800 g is taken out. The obtained liquid is a silica sol of transparent colloidal color and indicating SiO₂ concentration; 20.3 wt %, pH; 10.15, specific gravity; 1.130, viscosity; 14.5 mPa·s, electric conductivity; 3770 μS/cm and measured particle size by dynamic light scattering method (D1) is 117 nm. Therefore, D1/D2 ratio is 9.8.

### Example 1

Dispersions of following blending ratio for each materials for dye and color developing agent are prepared, and ground in wet condition by using a sand grinder to an average particle size of 0.5 μm.

<Dispersion of color developing agent>

| | | |
|---|---|---|
| 4-hydroxy-4′-isopropoxydiphenylsulfone | 6.0 | parts |
| 10% aqueous solution of polyvinyl alcohol | 18.8 | parts |
| water | 11.2 | parts |

<Dispersion of dye>

| | |
|---|---|
| 3-di-n-butylamino-6-methyl-7-anilinofluorane (OBD-2) | 3.0 parts |
| 10% aqueous solution of polyvinyl alcohol | 6.9 parts |
| water | 3.9 parts |

<Dispersion of sensitizer>

| | | |
|---|---|---|
| stearic acid amide (average particle size 0.4 μm) | 6.0 | parts |
| 10% aqueous solution of polyvinyl alcohol | 18.8 | parts |
| water | 11.2 | parts |

Above mentioned dispersions are mixed according to ratio mentioned below and a coating for thermally sensitive layer is obtained. The coating is coated and dried on a surface of woodfree paper having basic weight of 50 g/m² such that a coating amount after drying was 6 g/m². The resultant is treated by a supercalender so as Bekk smoothness to become 200 to 600 sec, and a thermally sensitive recording medium is obtained.

| Dispersion of color developing agent | 36.0 | parts |
|---|---|---|
| Dispersion of dye | 13.8 | parts |
| Dispersion of sensitizer | 36.0 | parts |
| 50% dispersion of aluminum hydroxide | 26.0 | parts |
| 30% dispersion of zinc stearate | 6.7 | parts |
| Acrylic polymer A (solid part; 40%) | 20.0 | parts |
| Monomer component | (ratio) | |
| Methyl methacrylate | 30 | parts |
| Butyl acrylate | 70 | parts |
| Vinyltrimethyl silane | 2 | parts |
| Acrylonitrile | 5 | parts |
| Chain colloidal silica of Synthesis | 20.0 | parts |
| Example 1 (SiO₂ conc.; 21.5%) | | |

### Example 2

By same process to Example 1 except using chain colloidal silica of Synthesis Example 2 in a process of formation of a thermally sensitive layer, a thermally sensitive recording medium is obtained.

### Example 3

By same process to Example 1 except using chain colloidal silica of Synthesis Example 3 in a process of formation of a thermally sensitive layer, a thermally sensitive recording medium is obtained.

### Example 4

By same process to Example 1 except using chain colloidal silica of Synthesis Example 4 in a process of formation of a thermally sensitive layer, a thermally sensitive recording medium is obtained.

### Example 5

By same process to Example 1 except using chain colloidal silica of Synthesis Example 5 in a process of formation of a thermally sensitive layer, a thermally sensitive recording medium is obtained.

### Example 6

By same process to Example 1 except using chain colloidal silica of Synthesis Example 6 in a process of formation of a thermally sensitive layer, a thermally sensitive recording medium is obtained.

### Example 7

By same process to Example 1 except using 20.0 parts of acidic (pH 2-4) chain colloidal silica prepared by treating chain colloidal silica sol of Synthesis Example 1 by following process instead of 20.0 parts of chain colloidal silica in a process of formation of a thermally sensitive layer, a thermally sensitive recording medium is obtained. That is, chain colloidal silica sol of Synthesis Example 1 is demineralized and condensed by an ultrafilter membrane of fractionated molecular weight 50,000 at room temperature using a plane ultrafiltration apparatus and treated by Umberlight 120B cation exchanging resin.

### Example 8

Dispersions of following blending ratio for each materials for dye and color developing agent are prepared, and ground in wet condition by using a sand grinder to an average particle size of 0.5 μm.

<Dispersion of color developing agent>

| | | |
|---|---|---|
| diphenylsulfone crosslinked compound (product of | 6.0 | parts |
| Nihon Soda Co., ltd. Comodity name D-90) | | |
| 10% aqueous solution of polyvinyl alcohol | 18.8 | parts |
| water | 11.2 | parts |

<Dispersion of dye>

| | |
|---|---|
| 3-di-n-butylamino-6-methyl-7-anilinofluorane (OBD-2) | 3.0 parts |
| 10% aqueous solution of polyvinyl alcohol | 6.9 parts |
| water | 3.9 parts |

<Dispersion of sensitizer>

| | | |
|---|---|---|
| stearic acid amide (average particle size 0.4 μm) | 6.0 | parts |
| 10% aqueous solution of polyvinyl alcohol | 18.8 | parts |
| water | 11.2 | parts |

Above mentioned dispersions are mixed according to ratio mentioned below and a coating for thermally sensitive layer is obtained. The coating is coated and dried on a surface of woodfree paper having basic weight of 50 g/m² such that a coating amount after drying was 6 g/m². The resultant is treated by a supercalender so as Bekk smoothness to become 200 to 600 sec, and a thermally sensitive recording medium is obtained. Components of acrylic polymer used in Examples 8-13 are shown in Table 2.

| | | |
|---|---|---|
| Dispersion of color developing agent | 36.0 | parts |
| Dispersion of dye | 13.8 | parts |
| Dispersion of sensitizer | 36.0 | parts |
| 50% dispersion of aluminum hydroxide | 26.0 | parts |
| 30% dispersion of zinc stearate | 6.7 | parts |
| aqueous emulsion of acrylic polymer a (solid part 40%) | 20.0 | parts |
| colloidal silica | 5.0 | parts |
| (product of Clariant Japan, commodity name; | | |
| Crebosol 40R12, average particle size; 12 nm) | | |

### Example 9-13

By same process to Example 8 except using aqueous emulsions of acrylic polymers b-g (solid parts 40%) instead of acrylic polymer a in a process of formation of a thermally sensitive layer, a thermally sensitive recording medium is obtained.

### Comparative Example 1

By same process to Example 1 except using 20 parts of acrylic polymer A and not blending chain colloidal silica in a process of formation of a thermally sensitive layer, a thermally sensitive recording medium is obtained.

### Comparative Example 2

By same process to Example 1 except using 40 parts of 10% polyvinylalcohol (product of Kuraray, commoditiy name PVA117) instead of 20.0 parts of acrylic polymer in a process of formation of a thermally sensitive layer, a thermally sensitive recording medium is obtained.

### Comparative Example 3

By same process to Example 1 except using 20 parts of acrylic emulsion/colloidal silica composite resin (product of Clariant Japan, commodity name; Movinyl 8020, solid part; 40%) instead of 20.0 parts of acrylic polymer and 20.0 parts of colloidal silica in a process of formation of a thermally sensitive layer, a thermally sensitive recording medium is obtained.

Component of acrylic polymer and construction of Examples and Comparative Examples are summarized in Table 1 and Table 2, and evaluation results of obtained thermally sensitive recording medium are summarized in Table 3.

TABLE 1

| | Chain | (D1: dynamic light | | | | |
|---|---|---|---|---|---|---|
| | colloidal | scattering method, D2: BET) | | | | Acrylic |
| | silica | D1 | D2 | D1/D2 | pH | polymer |
| Exam- | | | | | | |
| ple | | | | | | |
| 1 | Synthesis | 177 nm | 20.5 nm | 8.63 | 9.62 | A |
| | Ex. 1 (chain) | | | | | |
| 2 | Synthesis | 116 nm | 20.5 nm | 5.66 | 9.56 | A |
| | Ex. 2 (chain) | | | | | |
| 3 | Synthesis | 194 nm | 20.5 nm | 9.46 | 9.57 | A |
| | Ex. 3 (chain) | | | | | |
| 4 | Synthesis | 155 nm | 37.0 nm | 4.19 | 9.54 | A |
| | Ex. 4 (chain) | | | | | |
| 5 | Synthesis | 163 nm | 12.0 nm | 13.6 | 10.03 | A |
| | Ex. 5 (chain) | | | | | |
| 6 | Synthesis | 117 nm | 12.0 nm | 9.8 | 10.15 | A |
| | Ex. 6 (chain) | | | | | |
| 7 | Synthesis | 177 nm | 20.5 nm | 8.63 | 3.5 | A |
| | Ex. 1′ | | | | | |
| | (acidic) | | | | | |
| Compar- | | | | | | |
| ative | | | | | | |
| Exam- | | | | | | |
| ple | | | | | | |
| 1 | No | | | | | A |
| 2 | Synthesis | 177 nm | 20.5 nm | 8.64 | 9.62 | PVA-117 |
| | Ex. 1 (chain) | | | | | |
| 3 | composite | | | | | Movinyl |
| | | | | | | 8020 |

TABLE 2

| Acrylic polymer | | monomer | Blending ratio |
|---|---|---|---|
| Example 8 | a | methyl methacrylate | 30 |
| | | butyl acrylate | 70 |
| | | vinyl trimethylsilane | 2 |
| Example 9 | b | 2-ethylhexyl methacrylate | 40 |
| | | methyl acrylate | 60 |
| | | vinyltrimethoxy silane | 5 |
| Example 10 | c | methyl methacrylate | 80 |
| | | propyl acrylate | 20 |
| | | vinyl trimethylsilane | 2 |
| Example 11 | e | methyl methacrylate | 30 |
| | | butyl acrylate | 70 |
| | | vinyl trimethylsilane | 2 |
| | | styrene | 20 |
| Example 12 | f | 2-ethylhexyl methacrylate | 40 |
| | | methyl acrylate | 60 |
| | | vinyltrimethoxy silane | 5 |
| | | N-methylolacrylamide | 50 |
| Example 13 | g | methyl methacrylate | 30 |
| | | butyl acrylate | 70 |
| | | vinyl trimethylsilane | 2 |
| | | styrene | 20 |
| | | acrylonitrile | 50 |

TABLE 3

| | Color developing | | | |
|---|---|---|---|---|
| | sensitivity | Water | Printing | Dregs on |
| | (1)/(2) | resistance | aptitude | a head |
| Example 1 | 0.91/1.23 | ◯ | ◯ | ◯ |
| Example 2 | 0.88/1.20 | ◯ | ◯ | ◯ |
| Example 3 | 0.85/1.19 | ◯ | ◯ | ◯ |
| Example 4 | 0.87/1.25 | ◯ | ◯ | ◯ |
| Example 5 | 0.83/1.23 | ◯ | ◯ | ◯ |
| Example 6 | 0.85/1.23 | ◯ | ◯ | ◯ |
| Example 7 | 0.88/1.30 | ◯ | Δ | Δ |
| Example 8 | /1.25 | ◯ | ◯ | ◯ |
| Example 9 | /1.22 | ◯ | ◯ | ◯ |
| Example 10 | /1.27 | ◯ | ◯ | ◯ |
| Example 11 | /1.25 | ◯ | ◯ | ◯ |
| Example 12 | /1.17 | Δ | Δ | ◯ |
| Example 13 | /1.29 | ◯ | ◯ | ◯ |
| Comparative | 0.70/1.19 | ◯ | X | X |
| Example 1 | | | | |
| Comparative | 0.72/1.10 | X | ◯ | X |
| Example 2 | | | | |
| Comparative | 0.85/1.29 | X | X | X |
| Example 3 | | | | |

In color developing sensitivity (1)/(2), (1) shows the date measured by 0.25 mJ/dot, (2) shows the date measured by 0.34 mJ/dot.

### INDUSTRIAL APPLICABILITY

The thermally sensitive recording medium of the present invention is characterized that the strength of a thermally sensitive recording layer is improved, having good water resistance and printing aptitude, further heat resistance of recorded image is good. Further, accumulation of dregs on a head is not observed and is good at printing runnability and seal putting ability. That is, effect for actual use is very excellent.

1. A thermally sensitive recording medium comprising a thermally sensitive color developing layer containing colorless or pale colored basic leuco dye and a color developing agent as main components on a substrate, wherein said thermally sensitive recording layer is comprising an acrylic polymer obtained by copolymerization of alkyl acrylate, alkyl methacrylate and vinylsilane as monomer components and a colloidal silica.

2. The thermally sensitive recording medium of claim 1, wherein the acrylic polymer further comprises acrylonitrile as a monomer component.

3. The thermally sensitive recording medium of claim 1, wherein the acrylic polymer further comprises styrene as a monomer component.

4. A thermally sensitive recording medium comprising a thermally sensitive color developing layer containing colorless or pale colored basic leuco dye and a color developing agent as main components on a substrate, wherein said thermally sensitive recording layer is comprising an acrylic polymer and a colloidal silica possessing chain structure.

5. The thermally sensitive recording medium of claim 4, wherein the colloidal silica possessing chain structure is consisting of spherical colloidal silica particles of average particle size 10-50 nm and metal oxide containing silica which bond said spherical colloidal silica particles, and D1/D2, which is the ratio of particle size D1 nm measured by dynamic light scattering method and average particle size of spherical colloidal silica D2 nm measured by nitrogen absorbing method, is 3 or more, wherein said D1 is 50-500 nm and said spherical colloidal silica particles are linked in one plane like a rosary.

6. A thermally sensitive recording medium comprising a thermally sensitive color developing layer containing colorless or pale colored basic leuco dye and a color developing agent as main components on a substrate, wherein said thermally sensitive recording layer is comprising an acrylic polymer obtained by copolymerization of alkyl acrylate, alkyl methacrylate and vinylsilane as monomer components and a colloidal silica, wherein said colloidal silica possesses chain structure.

7. The thermally sensitive recording medium of claim 6, wherein the acrylic polymer further comprises acrylonitrile as a monomer component.

8. The thermally sensitive recording medium of claim 6, wherein the acrylic polymer further comprises styrene as a monomer component.

9. A thermally sensitive recording medium comprising a thermally sensitive color developing layer containing colorless or pale colored basic leuco dye and a color developing agent as main components on a substrate, wherein said thermally sensitive recording layer is comprising an acrylic polymer obtained by copolymerization of alkyl acrylate, alkyl methacrylate and vinylsilane as monomer components and a colloidal silica possessing chain structure, wherein said colloidal silica possessing chain structure is consisting of spherical colloidal silica particles of average particle size 10-50 nm and metal oxide containing silica which bond said spherical colloidal silica particles, and D1/D2, which is the ratio of particle size D1 nm measured by dynamic light scattering method and average particle size of spherical colloidal silica D2 nm measured by nitrogen absorbing method, is 3 or more, wherein said D1 is 50-500 nm and said spherical colloidal silica particles are linked in one plane like a rosary.

10. The thermally sensitive recording medium of claim 9, wherein said acrylic polymer further contains acrylonitrile.

11. The thermally sensitive recording medium of claim 9, wherein the acrylic polymer further contains styrene as a monomer component.
